(19) United States
(12) Patent Application Publication
(10) Pub. No.: US 2009/0262527 A1
(43) Pub. Date: Oct. 22, 2009

(54) High-Voltage Light Emitting Diode Circuit Having a Plurality of Critical Voltages and Light Emitting Diode Device Using the Same

(75) Inventor: Ming Huang CHOU, Datong District (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Top Crystal Technology, Inc., Miaoli County (TW)

(21) Appl. No.: 12/424,778

(22) Filed: Apr. 16, 2009

(30) Foreign Application Priority Data
Apr. 18, 2008 (TW) 097114236

(51) Int. Cl. B60Q 1/00

(52) U.S. Cl. 362/231; 362/227

(57) ABSTRACT

A high-voltage light emitting diode (LED) circuit having a plurality of critical voltages and an LED device using the same are described. The high-voltage LED circuit includes a first substrate, at least a first LED formed on the first substrate, and at least an impedance element formed on the first substrate and electrically connected in series with one end of the first LED. The first LED is connected in parallel with at least a second LED based on the characteristics of the impedance element, and the second LED has a polarity opposite to that of the first LED, such that the high-voltage LED circuit may be operated in an AC power supply environment, thereby improving the convenience of using the LEDs.

### CROSS-REFERENCE TO RELATED APPLICATIONS

This non-provisional application claims priority under 35 U.S.C. § 119(a) on Patent Application No(s). 097114236 filed in Taiwan, R.O.C. on Apr. 18, 2008 the entire contents of which are hereby incorporated by reference.

### BACKGROUND OF THE INVENTION

1. Field of Invention

The present invention relates to a light emitting diode (LED) circuit and an LED device, and more particularly to a high-voltage LED circuit having a plurality of critical voltages and an LED device using the same.

2. Related Art

With the development of material technology, the color and brightness of the light emitted by the light emitting diode (LED) have made dramatic progress. Various LED display technologies focus on true color and high brightness. The LED has a great potential to become a new-generation illumination equipment for lighting people's life.

In recent years, due to continuous improvement of the luminous efficiency and other properties of the LED, the market demand for the LED grows significantly. The reason why the LED achieves such a high market growth rate mainly lies in two impetuses. One is the replacement of cold cathode fluorescent lamp (CCFL) with LED in the LED display backlight source market. The other is the replacement of incandescent lamp and fluorescent lamp with LED in the common light source market. In the above two markets, the LED has advantages in environmental protection, energy saving, and good color expression. Laws and regulations relating environmental protection such as “Ban on the Use of Mercury in EU since 2006” are particularly the main reason of the market growth.

In the current diode illumination products, when a series circuit design is adopted, the failure of one LED may cause that the whole equipment cannot be used, and the failed LED needs to be replaced with a new one, which is inconvenient in use. If it intends to activate the LED illumination equipment segment by segment, an additional switching circuit needs to be designed for control, which may increase the manufacturing cost of the LED illumination equipment. U.S. Pat. No. 6,830,358 discloses an LED circuit. Although the LED circuit is applicable to a DC or AC power supply environment, it is a discrete component with a large size, and thus does not conform to the design trend toward light, thin, short, and small circuits. In addition, US Patent Publication No. 20050254243 discloses an LED circuit. Although the LED circuit is manufactured by a chip process and has a small volume, it can only be applied in an AC voltage environment. Further, the LEDs having the same polarity are all serially-connected, so that when one of the LEDs fails, the other LEDs cannot be used any longer, which is also inconvenient in use.

Therefore, it is in need of a high-voltage LED circuit having a plurality of critical voltages and an LED device using the same, so as to facilitate the use of the illumination device and reduce the manufacturing cost thereof.

### SUMMARY OF THE INVENTION

Accordingly, the present invention is a high-voltage LED circuit having a plurality of critical voltages and an LED device using the same, which enables LEDs to be operated in a DC or AC environment and activated by a plurality of critical voltages through a parallel loop and an impedance design of an impedance element, so as to facilitate the use of the LED circuit.

Therefore, in order to achieve the above objectives, a high-voltage LED chip having an impedance element of the present invention is operated in a DC voltage source environment. The LED chip comprises: a first substrate, made of an insulating and heat-resistant material; a first LED, formed on the first substrate, having a multiple quantum well (MQW) structure, and further having an electron blacking layer structure; and an impedance element, formed on the first substrate and electrically connected in series with one end of the first LED, in which the impedance element is a diode element or a resistance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

Further, in order to achieve the above objectives, a submount high-voltage LED chip of the present invention is operated in a DC voltage source environment. The LED chip comprises: a first substrate, made of an insulating and heat-resistant material; a first LED, formed on the first substrate, having an MQW structure, and further having an electron blacking layer structure; a second substrate, having a plurality of wires formed on a surface thereof, and an impedance element, formed on the second substrate, electrically connected to the wires, and electrically connected in series with one side of the first LED, in which the impedance element is a diode element or a resistance element. In practice, the second substrate may be a printed circuit board (PCB), a silicon substrate, or a ceramic material; and the ceramic material may comprise Al₂O₃, AlN, BeO, low-temperature co-fired ceramic (LTCC), and high-temperature co-fired ceramic (HTCC).

In addition, in order to achieve the above objectives, an LED device of the present invention comprises a base structure, a high-voltage LED chip having an impedance element, a light-receiving layer, and a lens. The base structure further comprises: a body, in which a chip base is formed in the body and is adapted to support the high-voltage LED chip having an impedance element; and a first lead frame and a second lead frame, separated from each other and having no electrical connection, in which the lead frames are fixed on the body.

The high-voltage LED chip having an impedance element comprises: a first substrate, fixed in the chip base; a first LED, formed on the first substrate, in which one end of the first LED is electrically connected to the first lead frame via a first wire; and an impedance element, formed on the first substrate, in which one end of the impedance element is electrically connected in series with the other end of the first LED, and the other end of the impedance element is electrically connected to the second lead frame via a second wire. Particularly, the high-voltage LED chip having an impedance element may be a combination of, but not limited to, red, blue, and green diode chips.

The light-receiving layer is covered on the high-voltage LED chip having an impedance element connected to the wires in the chip base. A diffusion powder may be further blended in the light-receiving layer. In addition, an optical-wave conversion layer may be further formed on the light-receiving layer.

The lens is bonded to the body and covered on the chip base. The lens may be made of glass, transparent plastic, or silica gel.

The present invention may achieve at least the following efficacies.

1. Through the impedance matching design of the impedance element, power supply specifications applicable to the LED circuit are no longer limited to voltages with particular multiplying factors (i.e., 3 V, 6 V, 9 V, 12 V, etc.), thereby expanding the range of applicable voltage specifications.

2. Through the parallel loop design, when one LED in the LED circuit fails, the other LEDs still maintain a normal operation, so as to facilitate the use of the LED circuit.

3. The design of a plurality of critical voltages enables the LEDs to be activated according to the set critical voltages, and replaces the design of segmented control using switching circuits in the prior art, so as to reduce the manufacturing cost of the illumination device.

### BRIEF DESCRIPTION OF THE DRAWINGS

The present invention will become more fully understood from the detailed description given herein below for illustration only, and thus are not limitative of the present invention, and wherein:

FIG. 1A is a schematic cross-sectional view of a high-voltage LED chip having an impedance element according to a first embodiment of the present invention;

FIG. 1B is a schematic cross-sectional view of a high-voltage LED chip having an impedance element according to a second embodiment of the present invention;

FIG. 1C is a schematic cross-sectional view of a high-voltage LED chip having an impedance element according to a third embodiment of the present invention;

FIG. 1D is a schematic cross-sectional view of a high-voltage LED chip having an impedance element according to a fourth embodiment of the present invention;

FIG. 1E is a schematic cross-sectional view of a submount high-voltage LED chip according to a fifth embodiment of the present invention;

FIG. 1F is a schematic cross-sectional view of a submount high-voltage LED chip according to a sixth embodiment of the present invention;

FIG. 1G is a schematic cross-sectional view of a submount high-voltage LED chip according to a seventh embodiment of the present invention;

FIG. 2A is a schematic cross-sectional view of an LED device according to an eighth embodiment of the present invention;

FIG. 2B is a schematic cross-sectional view of an LED device according to a ninth embodiment of the present invention;

FIG. 2C is a schematic view of an LED circuit having a plurality of critical voltages according to a tenth embodiment of the present invention;

FIG. 3A is a schematic view of an LED circuit having a plurality of critical voltages according to an eleventh embodiment of the present invention;

FIG. 3B is a schematic view of an LED circuit having a plurality of critical voltages according to a twelfth embodiment of the present invention;

FIG. 3C is a schematic view of an LED circuit having a plurality of critical voltages according to a thirteenth embodiment of the present invention;

FIG. 3D is a schematic view of an LED circuit having a plurality of critical voltages according to a fourteenth embodiment of the present invention;

FIG. 3E is a schematic view of an LED circuit having a plurality of critical voltages according to a fifteenth embodiment of the present invention;

FIG. 4A shows a voltage-current characteristic curve of the LED circuit having a plurality of critical voltages according to the eleventh embodiment of the present invention; and

FIG. 4B shows a voltage-current characteristic curve of the LED circuit having a plurality of critical voltages according to the twelfth embodiment of the present invention.

### DETAILED DESCRIPTION OF THE INVENTION

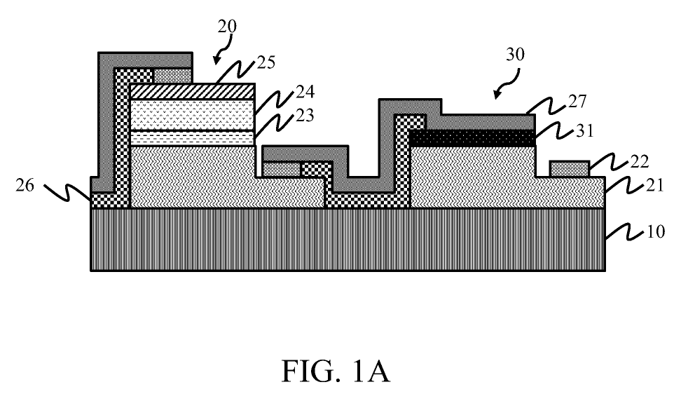

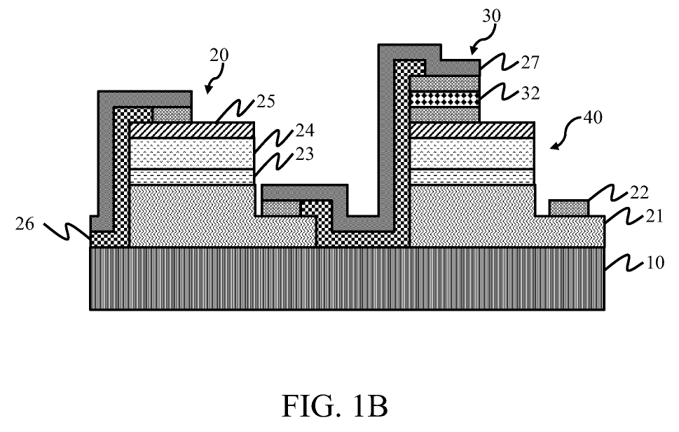

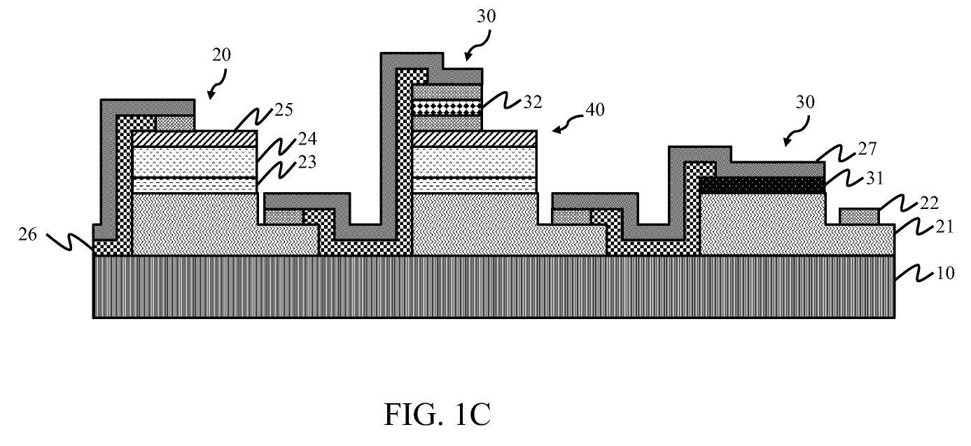

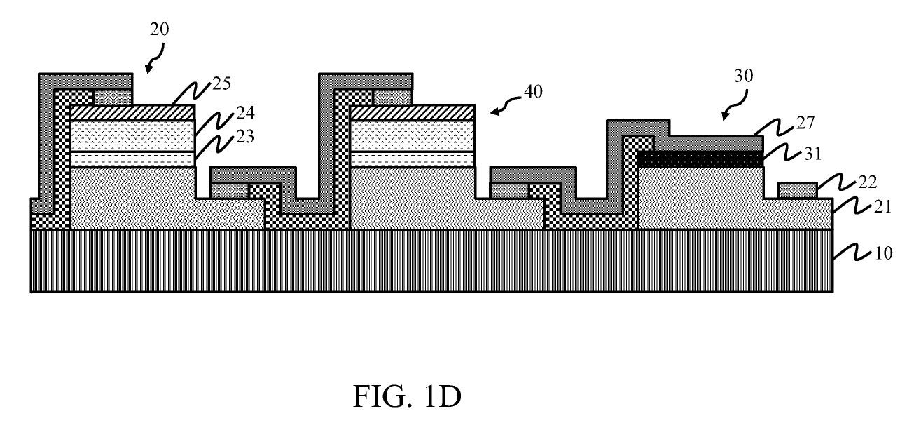

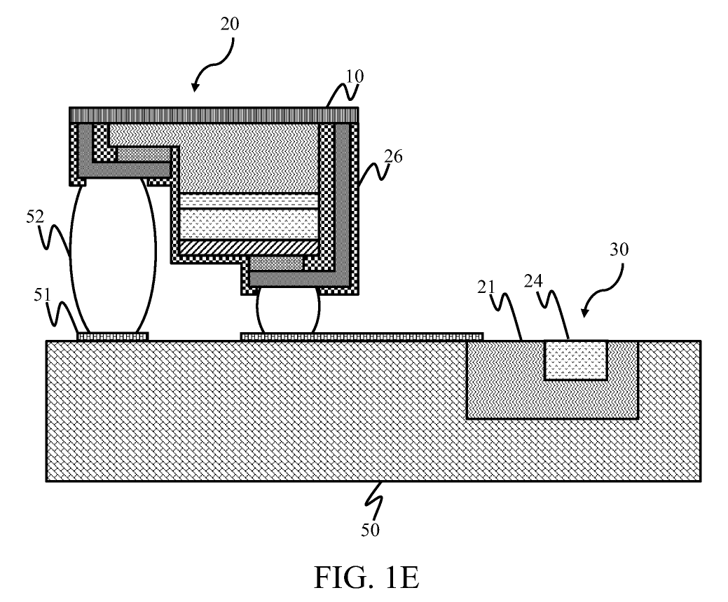

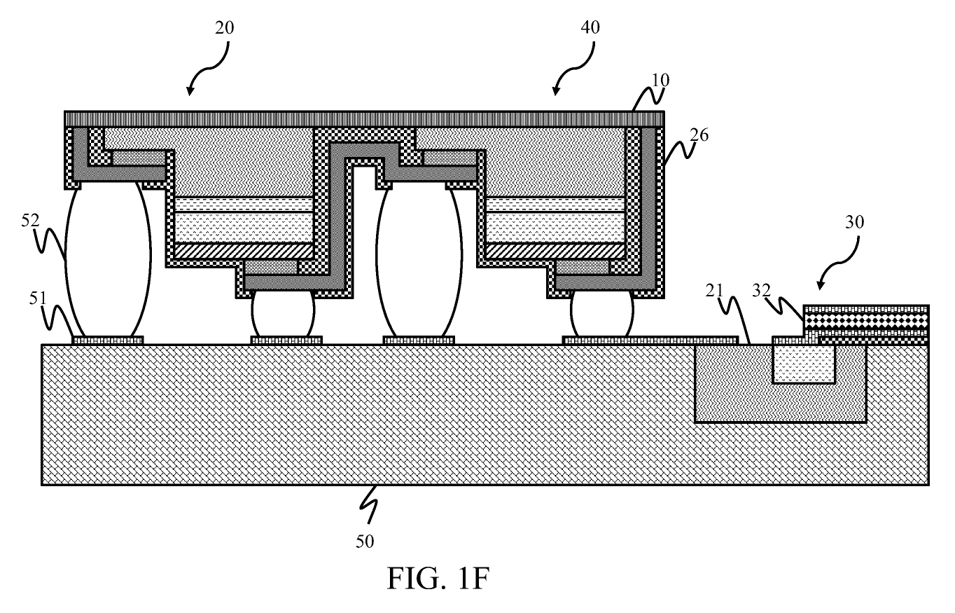

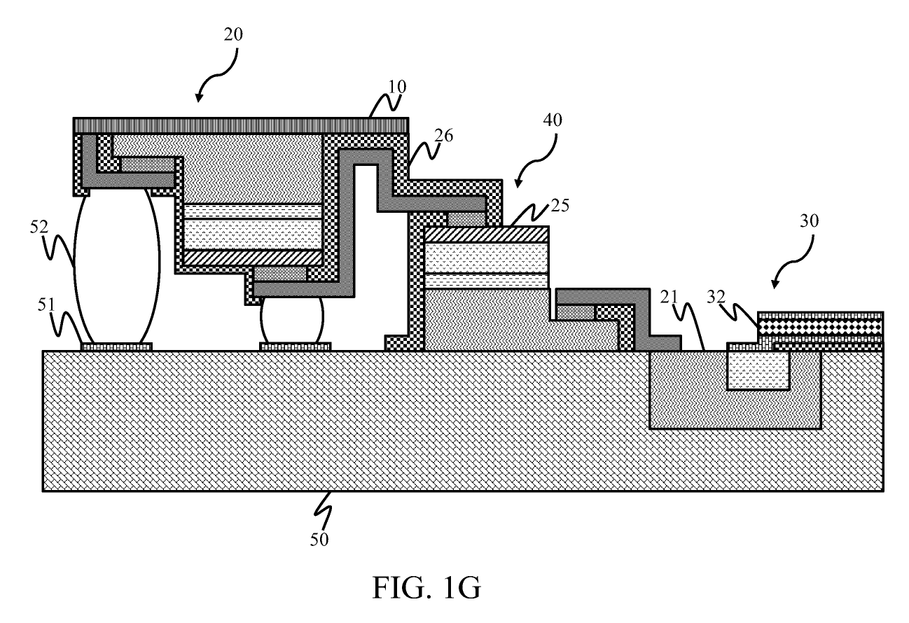

FIG. 1A is a schematic cross-sectional view of a high-voltage LED chip having an impedance element according to a first embodiment of the present invention. The high-voltage LED chip of the first embodiment is operated in a DC voltage source environment, and comprises a first substrate 10, a first LED 20, and an impedance element 30.

The first substrate 10 is made of an insulating and heat-resistant material.

The first LED 20 is formed on the first substrate 10, and comprises an N-type semiconductor layer 21, an Ohmic contact 22, a light emitting layer 23, a P-type semiconductor layer 24, a transparent current diffusion layer 25, an insulating layer 26, and an interconnecting metal wire 27. The first LED 20 has a multiple quantum well (MQW) structure and further has an electron blacking layer structure.

The impedance element 30 is formed on the first substrate 10 and electrically connected in series with one end of the first LED 20. The impedance element 30 is a diode element or a resistance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The impedance element 30 in FIG. 1A comprises an N-type semiconductor layer 21, an Ohmic contact 22, a Schockley diode 31, an insulating layer 26, and an interconnecting metal wire 27.

FIG. 1B is a schematic cross-sectional view of a high-voltage LED chip having an impedance element according to a second embodiment of the present invention. The high-voltage LED chip of the second embodiment is operated in an AC voltage source environment, and comprises a first substrate 10, a first LED 20, an impedance element 30, and a second LED 40.

The first substrate 10 is made of an insulating and heat-resistant material.

The first LED 20 is formed on the first substrate 10, and comprises an N-type semiconductor layer 21, an Ohmic contact 22, a light emitting layer 23, a P-type semiconductor layer 24, a transparent current diffusion layer 25, an insulating layer 26, and an interconnecting metal wire 27. The first LED 20 has an MQW structure and further has an electron blacking layer structure.

The second LED 40 is formed on the first substrate 10, has a polarity opposite to that of the first LED 20, and is connected in parallel with the first LED 20.

The impedance element 30 is formed on the first substrate 10 and electrically connected in series with one side of the first LED 20 or the second LED 40. The impedance element 30 is a diode element, a resistance element, or a capacitive impedance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The impedance element 30 in FIG. 1B comprises an N-type semiconductor layer 21, an Ohmic contact 22, a dielectric layer 32, an insulating layer 26, and an interconnecting metal wire 27.

Further, FIG. 1C is a schematic cross-sectional view of a high-voltage LED chip having an impedance element according to a third embodiment of the present invention. The high-voltage LED chip of the third embodiment is operated in an AC voltage source environment, and has a portion that is the same as the second embodiment in structure, so the details will not be described herein again.

In addition, FIG. 1D is a schematic cross-sectional view of a high-voltage LED chip having an impedance element according to a fourth embodiment of the present invention. The high-voltage LED chip of the fourth embodiment is operated in an AC voltage source environment, and has a portion that is the same as the second embodiment in structure, so the details will not be described herein again.

FIG. 1E is a schematic cross-sectional view of a submount high-voltage LED chip according to a fifth embodiment of the present invention. The high-voltage LED chip of the fifth embodiment is operated in a DC voltage source environment, and comprises a first substrate 10, a first LED 20, an impedance element 30, a second substrate 50, wires 51, and bumps 52.

The first substrate 10 is made of an insulating and heat-resistant material.

The first LED 20 is formed on the first substrate 10, and comprises an N-type semiconductor layer 21, an Ohmic contact 22, a light emitting layer 23, a P-type semiconductor layer 24, a transparent current diffusion layer 25, an insulating layer 26, and an interconnecting metal wire 27. The first LED 20 has an MQW structure and further has an electron blacking layer structure.

The impedance element 30 is formed on the second substrate 50, electrically connected to the wires 51, and electrically connected in series with one side of the first LED 20. The impedance element 30 is a diode element or a resistance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The second substrate 50 has a plurality of wires 51 formed on a surface thereof. The bumps 52 are disposed between the wires 51 and the interconnecting metal wire 27. In practice, the second substrate 50 may be a printed circuit board (PCB), a silicon substrate, or a ceramic material; and the ceramic material may comprise Al₂O₃, AlN, BeO, low-temperature co-fired ceramic (LTCC), and high-temperature co-fired ceramic (HTCC).

The impedance element 30 in FIG. 1E comprises an N-type semiconductor layer 21 and a P-type semiconductor layer 24.

FIG. 1F is a schematic cross-sectional view of a submount high-voltage LED chip according to a sixth embodiment of the present invention. The high-voltage LED chip of the sixth embodiment is operated in an AC voltage source environment, and comprises a first substrate 10, a first LED 20, an impedance element 30, a second LED 40, a second substrate 50, wires 51, and bumps 52.

The first substrate 10 is made of an insulating and heat-resistant material.

The first LED 20, formed on the first substrate 10 and electrically connected to the wires 51, comprises an N-type semiconductor layer 21, an Ohmic contact 22, a light emitting layer 23, a P-type semiconductor layer 24, a transparent current diffusion layer 25, an insulating layer 26, and an interconnecting metal wire 27. The first LED 20 has an MQW structure and further has an electron blacking layer structure.

The second LED 40 is formed on the first substrate 10 (as shown in FIG. 1F) or the second substrate 50 (as shown in FIG. 1G), has a polarity opposite to that of the first LED 20, and is electrically connected in parallel with the first LED 20.

The second substrate 50 has a plurality of wires 51 formed on a surface thereof. The bumps 52 are disposed between the wires 51 and the interconnecting metal wire 27. In practice, the second substrate 50 may be a PCB, a silicon substrate, or a ceramic material; and the ceramic material may comprise Al₂O₃, AlN, BeO, LTCC, and HTCC.

The impedance element 30 is formed on the second substrate 50, electrically connected to the wires 51, and electrically connected in series with one side of the first LED 20 or the second LED 40. The impedance element 30 is a diode element, a resistance element, or a capacitive impedance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The impedance elements 30 in FIGS. 1F and 1G both comprise an N-type semiconductor layer 21, a P-type semiconductor layer 24, a dielectric layer 32, an insulating layer 26, and wires 51.

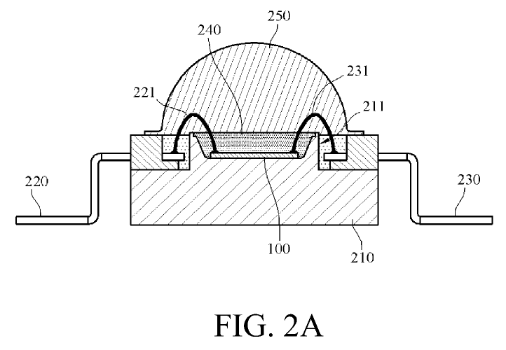

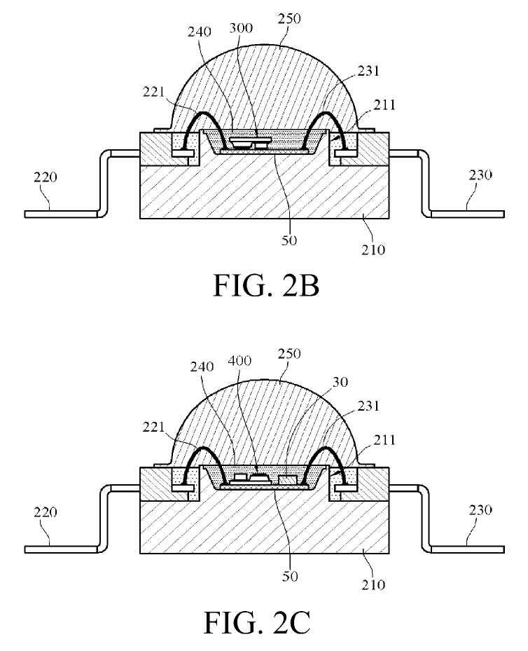

FIG. 2A is a schematic cross-sectional view of an LED device according to a seventh embodiment of the present invention. The high-voltage LED chip of the seventh embodiment is operated in a DC voltage source environment, and comprises a base structure 200, a high-voltage LED chip 100 having an impedance element, a light-receiving layer 240, and a lens 250.

The base structure 200 comprises a body 210, a first lead frame 220, and a second lead frame 230.

A chip base 211 is formed in the body 210 and is adapted to support the high-voltage LED chip 100 having an impedance element.

The first lead frame 220 and the second lead frame 230 are made of a metal. The two lead frames, separated from each other and having no electrical connection, are fixed on the body 210.

The high-voltage LED chip 100 having an impedance element (as the structure of the first embodiment in the present invention) comprises: a first substrate 10, fixed in the chip base 211; a first LED 20, formed on the first substrate 10, in which one end of the first LED 20 is electrically connected to the first lead frame 220 via a first wire 221; and an impedance element 30, formed on the first substrate 10, in which one end of the impedance element 30 is electrically connected in series with the other end of the first LED 20, and the other end of the impedance element 30 is electrically connected to the second lead frame 230 via a second wire 231. Particularly, the high-voltage LED chip 100 having an impedance element may be a combination of, but not limited to, red, blue, and green diode chips.

The light-receiving layer 240 is a transparent resin having a high light transmittance or a transparent colloid, and is covered on the high-voltage LED chip 100 having an impedance element connected to the wires in the chip base 211. A diffusion powder may be further blended in the light-receiving layer 240. In addition, an optical-wave conversion layer may be further formed on the light-receiving layer 240.

The lens 250 is bonded to the body 210 and covered on the chip base 211, such that the high-voltage LED chip 100 having an impedance element achieves an optimal optical field distribution when emitting light. The lens 250 may be made of glass, transparent plastic, or silica gel.

In addition, the high-voltage LED chip 100 having an impedance element further comprises at least a second LED 40 (as the structure of the second embodiment in the present invention). The second LED 40 is formed on the first substrate 10, has a polarity opposite to that of the first LED 20, and is connected in parallel with the first LED 20, such that the high-voltage LED chip 100 having an impedance element may be operated in an AC power supply environment.

FIG. 2B is a schematic cross-sectional view of an LED device according to an eighth embodiment of the present invention. The LED device comprises a base structure 200, a submount high-voltage LED chip 300, a light-receiving layer 240, and a lens 250.

The base structure 200 comprises a body 210, a first lead frame 220, and a second lead frame 230.

A chip base 211 is formed in the body 210 and is adapted to support the submount high-voltage LED chip 300.

The first lead frame 220 and the second lead frame 230 are made of a metal. The two lead frames, separated from each other and having no electrical connection, are fixed on the body 210.

The submount high-voltage LED chip 300 (as the structure of the fifth embodiment in the present invention) comprises: a first substrate 10, fixed in the chip base 211; a first LED 20, formed on the first substrate 10, in which one end of the first LED 20 is electrically connected to the first lead frame 220 via a first wire 221; and an impedance element 30, formed on the second substrate 50, in which one end of the impedance element 30 is electrically connected in series with the other end of the first LED 20, and the other end of the impedance element 30 is electrically connected to the second lead frame 230 via a second wire 231. Particularly, the submount high-voltage LED chip 300 may be a combination of, but not limited to, red, blue, and green diode chips.

The light-receiving layer 240 is a transparent resin having a high light transmittance or a transparent colloid, and is covered on the submount high-voltage LED chip 300 connected to the wires in the chip base 211. A diffusion powder may be further blended in the light-receiving layer 240. In addition, an optical-wave conversion layer may be further formed on the light-receiving layer 240.

The lens 250 is bonded to the body 210 and covered on the chip base 211, such that the submount high-voltage LED chip 300 achieves an optimal optical field distribution when emitting light. The lens 250 may be made of glass, transparent plastic, or silica gel.

In addition, the submount high-voltage LED chip 300 further comprises at least a second LED 40 (as the structure of the sixth embodiment in the present invention). The second LED 40 is formed on the first substrate 10 or the second substrate 50 (as the structure of the seventh embodiment in the present invention), has a polarity opposite to that of the first LED 20, and is connected in parallel with the first LED 20, such that the submount high-voltage LED chip 300 may be operated in an AC power supply environment.

FIG. 2C is a schematic cross-sectional view of an LED device according to a ninth embodiment of the present invention. The LED device comprises a base structure 200, an LED chip 400, an impedance element 30, a light-receiving layer 240, and a lens 250.

The base structure 200 comprises a body 210, a first lead frame 220, and a second lead frame 230.

A chip base 211 is formed in the body 210 and is adapted to support the LED chip 400.

The first lead frame 220 and the second lead frame 230 are made of a metal. The two lead frames, separated from each other and having no electrical connection, are fixed on the body 210.

The LED chip 400 comprises: a first substrate 10, fixed in the chip base 211; at least a first LED 20, formed on the first substrate 10, in which one end of the first LED 20 is electrically connected to the first lead frame 220 via a first wire 221; and an impedance element 30, fixed in the chip base 211, in which one end of the impedance element 30 is electrically connected in series with the other end of the first LED 20, and the other end of the impedance element 30 is electrically connected to the second lead frame 230 via a second wire 231.

The light-receiving layer 240 is a transparent resin having a high light transmittance or a transparent colloid, and is covered on the LED chip 400 connected to the wires in the chip base 211. A diffusion powder may be further blended in the light-receiving layer 240. In addition, an optical-wave conversion layer may be further formed on the light-receiving layer 240.

The lens 250 is bonded to the body 210 and covered on the chip base 211, such that the LED chip 400 achieves an optimal optical field distribution when emitting light. The lens 250 may be made of glass, transparent plastic, or silica gel.

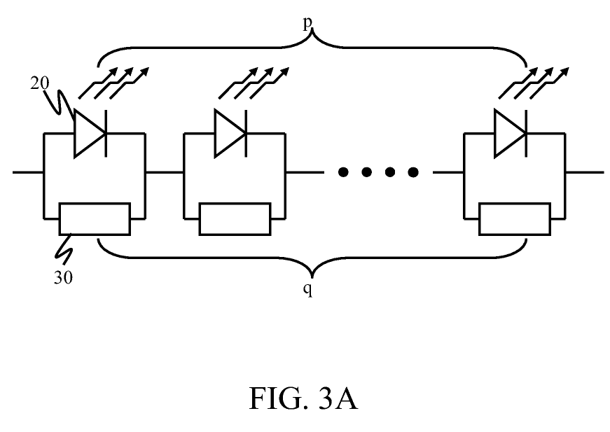

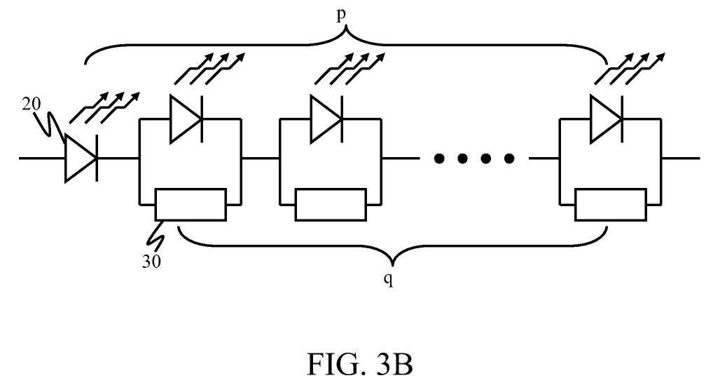

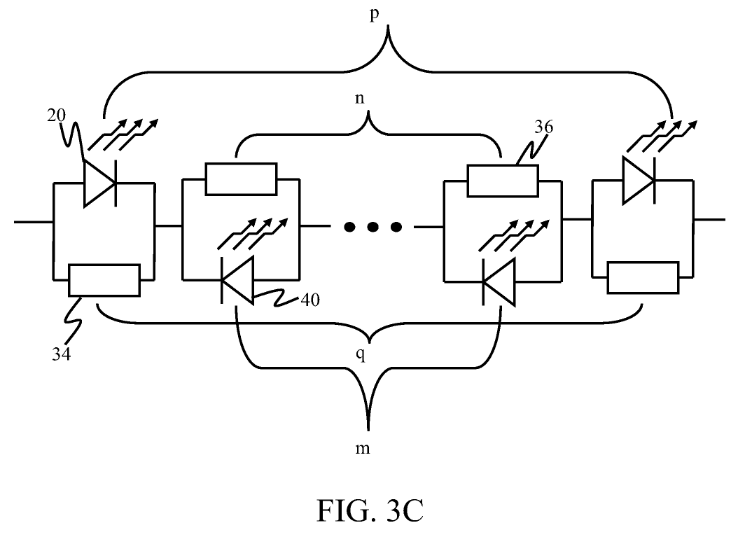

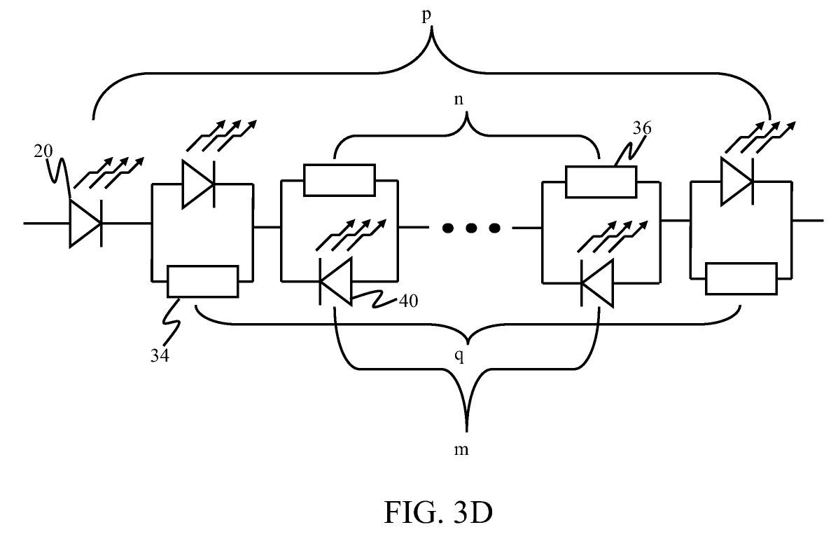

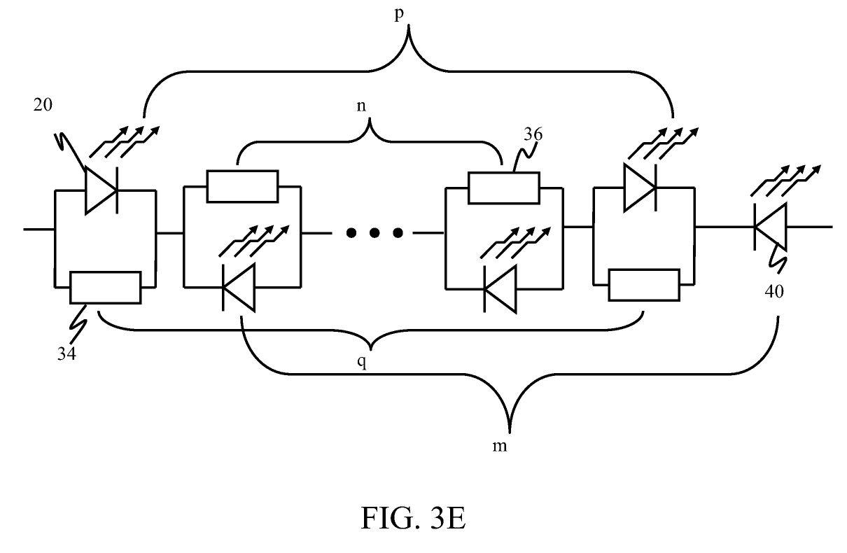

FIG. 3A is a schematic view of an LED circuit having a plurality of critical voltages according to a tenth embodiment of the present invention. The LED circuit is operated in a DC voltage source environment, and comprises p first LEDs 20 connected in series with one another and q impedance elements 30.

Each of the p first LEDs 20 connected in series with one another has an MQW structure and further has an electron blacking layer structure.

The q impedance elements 30 are connected in parallel with the first LEDs 20 in a one-to-one manner. Each of the impedance elements 30 is a diode element or a resistance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The value of p is an integer greater than or equal to 2, and the value of q is smaller than the value of p (as shown in FIG. 3B) or equal to the value of p (as shown in FIG. 3A).

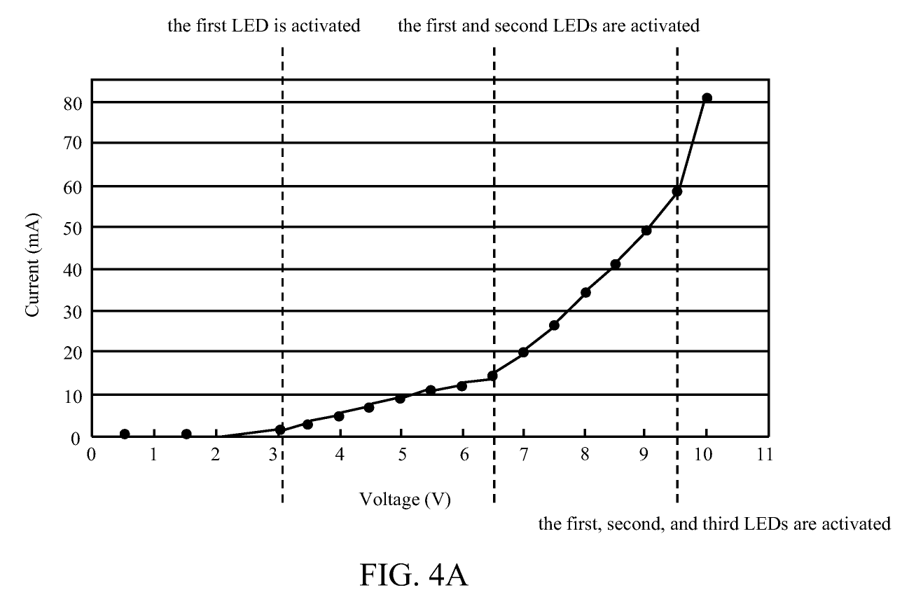

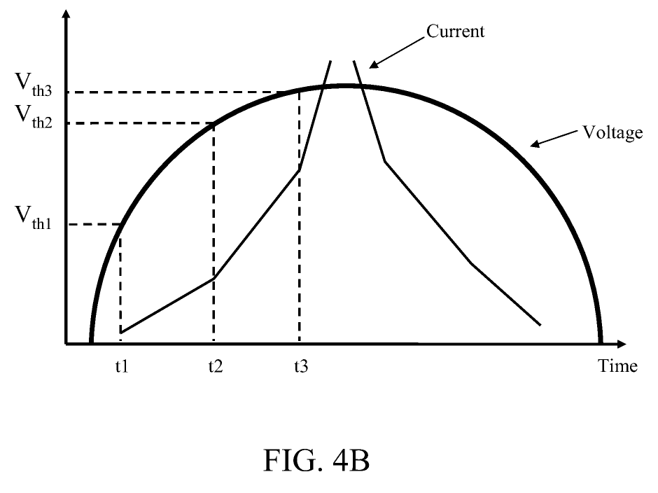

FIG. 4A shows a voltage-current characteristic curve of an LED circuit having a plurality of critical voltages according to an eleventh embodiment of the present invention. In FIG. 4A, three LEDs are provided as an example for illustration (i.e., p=3, and q=2). A first critical voltage (V^{th 1}) is smaller than a second critical voltage (V^{th 2}), and the second critical voltage (V^{th 2}) is smaller than a third critical voltage (V^{th 3}). Through the impedance matching design of the impedance element, the LED circuit may be activated by a plurality of critical voltages, such that the effect of activating segment by segment the LEDs for illumination without using any additional switching circuit for control is achieved, and the manufacturing cost is further reduced.

FIG. 3C is a schematic view of an LED circuit having a plurality of critical voltages according to a twelfth embodiment of the present invention. The LED circuit is operated in an AC voltage source environment, and comprises p first LEDs 20 connected in series with one another, q first impedance elements 34, n second impedance elements 36, and m second LEDs 40 connected in series with one another.

Each of the p first LEDs connected in series with one another has an MQW structure and further has an electron blacking layer structure.

The q first impedance elements 34 are connected in parallel with the first LEDs 20 in a one-to-one manner. Each of the first impedance elements 34 is a diode element, a resistance element, or a capacitive impedance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The m second LEDs 40 connected in series with one another are connected in parallel with the p first LEDs 20 connected in series with one another, and have a polarity opposite to that of the first LEDs 20.

The n second impedance elements 36 are connected in parallel with the second LEDs 40 in a one-to-one manner. Each of the second impedance elements 36 is a diode element, a resistance element, or a capacitive impedance element. In practice, the diode element may be a semiconductor pn junction, a Schockley diode, a semiconductor heterojunction, an organic electro-luminescent material, or a polymer electro-luminescent material; and the resistance element may be an Ohmic contact resistance or a thin-film wire resistance.

The values of p and m are integers greater than or equal to 2, the value of q is smaller than the value of p (as shown in FIG. 3D) or equal to the value of p (as shown in FIG. 3C), and the value of n is smaller than the value of m (as shown in FIG. 3D) or equal to the value of m (as shown in FIG. 3E).

FIG. 4B shows a voltage-current characteristic curve of the LED circuit having a plurality of critical voltages according to the twelfth embodiment of the present invention. In FIG. 4B, a positive half cycle of an AC power supply is provided as an example for illustration. A first critical voltage (V^{th 1}) is smaller than a second critical voltage (V^{th 2}), and the second critical voltage (V^{th 2}) is smaller than a third critical voltage (V^{th 3}). The three critical voltages are corresponding to three time points (a first time t1, a second time t2, and a third time t3), respectively.

In addition, the LED circuits having a plurality of critical voltages of the tenth embodiment, the eleventh embodiment, the twelfth embodiment, the thirteenth embodiment, the fourteenth embodiment, and the fifteenth embodiment of the present invention may be fabricated into integrated circuits.

Through such a high-voltage LED circuit having a plurality of critical voltages and an LED device using the same, the LED circuit may be activated by a plurality of critical voltages, such that the effect of activating segment by segment the LEDs for illumination without using any additional switching circuit for control is achieved, and the manufacturing cost is further reduced. Moreover, through the impedance matching and parallel design, the LED circuit is not only applicable to a wider range of voltage specifications, but also maintains a normal operation when some LEDs fail, which is quite convenient in use.

What is claimed is:

1. A high-voltage light emitting diode (LED) chip having an impedance element, comprising:
a first substrate;
at least a first LED, formed on the first substrate; and
at least an impedance element, formed on the first substrate and electrically connected in series with one end of the first LED.

2. The high-voltage LED chip having an impedance element according to claim 1, wherein the first LED has a multiple quantum well (MQW) structure.

3. The high-voltage LED chip having an impedance element according to claim 2, wherein the LED having the MQW structure further has an electron blacking layer structure.

4. The high-voltage LED chip having an impedance element according to claim 1, wherein the impedance element is a diode element or a resistance element.

5. The high-voltage LED chip having an impedance element according to claim 4, wherein the diode element is a semiconductor pn junction, a Schockley diode, a semiconductor heterojunction, an organic electro-luminescent material, or a polymer electro-luminescent material.

6. The high-voltage LED chip having an impedance element according to claim 4, wherein the resistance element is an Ohmic contact resistance or a thin-film wire resistance.

7. The high-voltage LED chip having an impedance element according to claim 1, further comprising: at least a second LED formed on the first substrate, wherein the second LED has a polarity opposite to that of the first LED and is connected in parallel with the first LED, and the impedance element is formed on the first substrate and electrically connected in series with one end of the second LED.

8. A submount high-voltage light emitting diode (LED) chip, comprising:
a second substrate, formed with a plurality of wires;
at least an LED chip, formed on the second substrate, the LED chip comprising:
a first substrate; and
at least a first LED, formed on the first substrate and electrically connected to the wires; and
at least an impedance element, formed on the second substrate, electrically connected to the wires, and electrically connected in series with one side of the first LED.

9. The submount high-voltage LED chip according to claim 8, wherein the second substrate is selected from a group consisting of a printed circuit board (PCB), a silicon substrate, and a ceramic material.

10. The submount high-voltage LED chip according to claim 9, wherein the ceramic material is selected from a group consisting of Al₂O₃, AlN, BeO, low-temperature co-fired ceramic (LTCC), and high-temperature co-fired ceramic (HTCC).

11. The submount high-voltage LED chip according to claim 8, wherein the LED has a multiple quantum well (MQW) structure.

12. The submount high-voltage LED chip according to claim 11, wherein the LED having the MQW structure further has an electron blacking layer structure.

13. The submount high-voltage LED chip according to claim 8, wherein the impedance element is a diode element or a resistance element.

14. The submount high-voltage LED chip according to claim 13, wherein the diode element is a semiconductor pn junction, a Schockley diode, a semiconductor heterojunction, an organic electro-luminescent material, or a polymer electro-luminescent material.

15. The submount high-voltage LED chip according to claim 13, wherein the resistance element is an Ohmic contact resistance or a thin-film wire resistance.

16. The submount high-voltage LED chip according to claim 8, further comprising: at least a second LED formed on the first substrate or the second substrate, wherein the second LED has a polarity opposite to that of the first LED and is electrically connected in parallel with the first LED, and the impedance element is formed on the second substrate, electrically connected to the wires, and electrically connected in series with one side of the second LED.

17. A light emitting diode (LED) device, comprising:
a base structure, comprising:
a body, wherein a chip base is formed in the body; and
at least two lead frames, separated from each other and having no electrical connection, wherein the lead frames are fixed on the body;
at least a high-voltage LED chip having an impedance element, comprising:
a first substrate, fixed in the chip base;
at least a first LED, formed on the first substrate, wherein one end of the first LED is electrically connected to one lead frame via a first wire; and
at least an impedance element, formed on the first substrate, wherein one end of the impedance element is electrically connected in series with the other end of the first LED, and the other end of the impedance element is electrically connected to the other lead frame via a second wire;
a light-receiving layer, covered on the high-voltage LED chip connected to the wires in the chip base; and
a lens, bonded to the body and covered on the chip base.

18. The LED device according to claim 17, wherein the high-voltage LED chip having an impedance element further comprises at least a second LED, formed on the first substrate, having a polarity opposite to that of the first LED, and connected in parallel with the first LED.

19. The LED device according to claim 17, wherein the high-voltage LED chip having an impedance element is capable of emitting at least two colors of light, and a diffusion powder is further blended in the light-receiving layer covered on the high-voltage LED chip having an impedance element.

20. The LED device according to claim 17, wherein the high-voltage LED chip having an impedance element is a high-voltage LED chip having an impedance element that emits a blue light, and an optical-wave conversion layer is further formed on the light-receiving layer covered on the high-voltage LED chip having an impedance element.
